(19) United States
(12) Patent Application Publication
(10) Pub. No.: US 2009/0204362 A1
(43) Pub. Date: Aug. 13, 2009

(54) INDOOR LOCATION DETERMINATION SYSTEM AND METHOD

(76) Inventors: Sung Kweon PARK, Suwon-si (KR); Joon Oo Kim, Suwon-si (KR); Yun Je Oh, Yongin-si (KR); Joon Hyuk Kang, Seoul (KR); Na Young Kim, Daejeon Metropolitan City (KR); Jeong Su Lee, Daejeon Metropolitan City (KR); Su Jin Kim, Daejeon Metropolitan City (KR); Jae Hwan Kim, Daejeon Metropolitan City (KR)

Correspondence Address: CHA & REITER, LLC, 210 ROUTE 4 EAST STE 103, PARAMUS, NJ, 07652, US

(21) Appl. No.: 12/370,704

(22) Filed: Feb. 13, 2009

(30) Foreign Application Priority Data
Feb. 13, 2008 (KR) 10-2008-0012869

(51) Int. Cl. G06F 15/00

(52) U.S. Cl. 702/150

(57) ABSTRACT

Disclosed are a system and a method for an indoor location determination using a matrix pencil. The system comprises a transmitter node that creates and transmits a transmission packet having a plurality of same symbols. A receiver node receives the transmission packet, calculates a delay time by using the symbols in the transmission packet and a matrix pencil algorithm, and calculates a distance between the transmitter node and the receiver node by using the delay time. The delay time estimation using the matrix pencil can reduce an error ratio and therefore can estimate more exactly the distance between the nodes.

### CLAIM OF PRIORITY

This application claims the benefit of the earlier filing date, pursuant to 35 USC 119, to that patent application entitled “INDOOR LOCATION DETERMINATION SYSTEM AND METHOD” filed in the Korean Intellectual Property Office on Feb. 13, 2008 and assigned Serial No. 10-2008-0012869, the contents of which are incorporated herein by reference.

### BACKGROUND OF THE INVENTION

1. Field of the Invention

The present invention relates to location technology and, more particularly, to an indoor location determination system and a method thereof, which may allow a more exact measurement of the distance between two points by using a matrix pencil.

2. Description of the Related Art

Indoor location determination technology is a method for measuring the motion of an object in a room or a building. As one of such technologies, a technique for determining the distance between two points, (hereinafter, referred to as nodes) by using radio-frequency waves such as ultrasonic waves or infrared rays has been researched and developed. SSR (Signal strength Ranging), TOA (Time of Arrival), TDOA (Time Difference of Arrival), and AOA (Angle of Arrival) are well-known examples of indoor location determination technologies.

SSR is a method for estimating the distance between a transmitter node and a receiver node by using the extent of signal strength. The distance estimation using SSR is, however, seriously affected by channel conditions. Particularly, an error in measurement is increased due to NLOS (non-line of sight) channel conditions or multipath fading.

AOA is a method for estimating the location of a target object by measuring the angle between two nodes. However, an error in measurement is increased under NLOS(Non-Line Of Sight) channel conditions.

TOA and TDOA use a time of delivery of signals between a transmitter node and a receiver node to estimate the distance between the two nodes. Particularly, TOA uses absolute values in delivery time at the two nodes, whereas TDOA uses a relative difference in delivery time between two nodes.

These methods, such as TOA or TDOA, for ascertaining the location of each node by using a time or time difference have difficulty in calculating an exact time difference under the influence of environmental conditions. For example, signals starting from a transmitter node are reflected by the wall or obstacles, so multiple paths may be formed between a transmitter node and a receiver node. Accordingly, a receiver node receives overlapped signals through the multiple paths and thereby may often fail to measure exactly the arrival time of a real transmission signal.

### BRIEF SUMMARY OF THE INVENTION

According to an aspect of the present invention, provided is a location determination method that comprises creating and transmitting a transmission packet having a plurality of same symbols at a transmitter node, receiving the transmission packet at a receiver node, calculating a delay time by using the symbols in the transmission packet and a matrix pencil algorithm and calculating a distance between the transmitter node and the receiver node by using the delay time.

According to another aspect of the present invention, provided is a location determination system that comprises a transmitter node creating and transmitting a transmission packet having a plurality of same symbols and a receiver node receiving the transmission packet and calculating a delay time by using the symbols in the transmission packet and a matrix pencil algorithm.

### BRIEF DESCRIPTION OF THE DRAWINGS

FIG. 1 is a block diagram showing an indoor location determination system in accordance with an exemplary embodiment of the present invention.

FIG. 2 is a flow diagram showing an indoor location determination method in accordance with an exemplary embodiment of the present invention.

FIG. 3 is a view showing an exemplary matrix pencil and MUSIC algorithms.

FIG. 4 is a graph showing a ranging error with regard to CSS PHY of IEEE802.15.4a.

FIG. 5A is a view showing simulation conditions of an indoor location determination method in accordance with an exemplary embodiment of the present invention.

FIG. 5B is a graph showing a ranging error in 2-ray channel model according to conditions given in FIG. 5A.

### DETAILED DESCRIPTION OF THE INVENTION

Exemplary, non-limiting embodiments of the present invention are described more fully herein, with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Well-known configurations and processes may be not described or illustrated in detail to avoid obscuring the essence of the present invention.

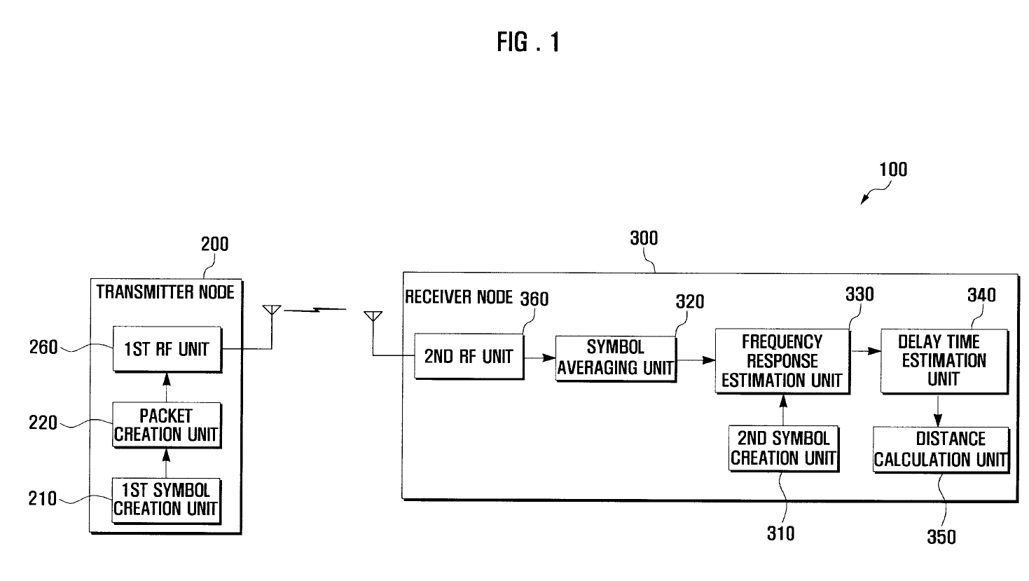

FIG. 1 is a block diagram showing an indoor location determination system in accordance with an exemplary embodiment of the present invention.

Referring to FIG. 1, the system 100 for indoor location determination includes a transmitter node 200 and a receiver node 300.

The transmitter node 200 creates transmission packets, each of which has a number of same first symbols, and transmits them. For this, the transmitter node 200 in this embodiment has a first symbol creation unit 210, a packet creation unit 220, and a first radio frequency (RF) unit 260.

The first symbol creation unit 210 creates first symbols to be included within the transmission packet, and sends them to the packet creation unit 220. The first symbol in this embodiment is formed of a chirp signal, having known chirp duration and frequency shift. The first symbols may also have a known spacing so as to occupy a known time period. That is, the first symbol creation unit 210 produces each first symbol by means of a chirp signal and delivers it to the packet creation unit 220.

Using the first symbols sent from the first symbol creation unit 210, the packet creation unit 220 creates the transmission packet.

The transmission packet transmits signals that are received by receiver node 300. Receiver node 300 measures the distance between the transmitter node 200 and the receiver node 300 on the basis of a delivery time for which the transmission packet travels from the transmitter node 200 to the receiver node 300, in accordance with the principles of the invention

In the embodiment described herein, the packet creation unit 220 puts the first symbols into a preamble section of the transmission packet when creating the packet. The present invention need not, however, be limited to this described configuration and, thus, may create a transmission packet having the first symbols included within a data section instead of the preamble section. Furthermore, the packet creation unit 220 disposes continuously a plurality of same first symbols in the transmission packet. For example, the transmission packet in this embodiment has eight first symbols in the preamble section. However, the number of first symbols included in the packet need not be limited to the number recited above or a specific value and may vary dependent upon factors such as Bit Error Rate, transmission overhead, etc. or may be arbitrarily set based on a desired number of symbols (e.g., a prime number of symbols).

The first RF unit 260 performs functions of transmitting and receiving data for wireless communications. This RF unit 260 includes an RF transmitter that up-converts the frequency of transmitted signals and amplifies the transmitted signals, and an RF receiver that amplifies received signals and down-converts the frequency of the received signals. Particularly, the first RF unit 260 not only delivers data, received through a wireless channel, to a control unit, but also sends the transmission packet, outputted from the packet creation unit 220, through a wireless channel.

The receiver node 300 receives the transmission packet sent from the transmitter node 200, and estimates a delay time by using the first symbols included in the packet using, in a preferred embodiment of the invention, a matrix pencil algorithm. Thus, the receiver node 300 in this embodiment includes a second RF unit 360, a symbol averaging unit 320, a second symbol creation unit 310, a frequency response estimation unit 330, a delay time estimation unit 340, and a distance calculation unit 350.

The second RF unit 360 performs the same functions as the first RF unit 260 of the transmitter node 200. That is, the second RF unit 360 performs functions of transmitting and receiving data for wireless communications. Particularly, the second RF unit 360 receives the packet sent from the transmitter node 200, and sends it to the symbol averaging unit 320.

The symbol averaging unit 320 calculates the average of first symbols, e.g., eight first symbols, included in the packet so as to acquire time diversity gains. Through this, the symbol averaging unit 320 can obtain better symbols with reduced noise. Specifically, a single symbol is produced as a single chirp signal. Therefore, by averaging the amplitude of chirp signals of eight symbols, the symbol averaging unit 320 can deal with eight symbols just like one symbol.

For example, let's suppose eight symbols sequentially received have values S_{—}1(t), S_{—}2(t), . . . , S_{—}8(t), respectively, and noises have values N_{—}1(t), N_{—}2(t), . . . , N_{—}8(t), respectively. Here, the average value of noises is smaller than respective noise values N_{—}1(t), N_{—}2(t), . . . , N_{—}8(t), so a noise may be reduced. Also, the average value of symbols S_{—}1(t), S_{—}2(t), . . . , S_{—}8(t) may be regarded as the value of one symbol.

These averages may be represented as:

N_{—}1(t)+N_{—}2(t)+ . . . +N_{—}8(t)≈0,

{S_{—}1(t)+S_{—}2(t)+ . . . S_{—}8(t)}/8≈S_{—}k(t) (1)

wherein k=1, 2, . . . , 8.

In Equation 1, the average of noises approximates to zero. This means that SNR (Signal to Noise Ratio) is improved in case of receiving eight symbols rather than in case of receiving a single symbol. The time required for receiving eight symbols is naturally greater than the time required for receiving a single symbol. However, since SNR is improved by averaging, it is possible to acquire time diversity gains. Additionally, one symbol is generally used for executing a matrix pencil algorithm. Since the average value of eight symbols is used like one symbol, it is possible to apply a matrix pencil algorithm.

The second symbol creation unit 310 has the same configuration as the first symbol creation unit 210. The second symbol creation unit 310 produces the same symbols as is expected to be received, and sends them to the frequency response estimation unit 330. In this embodiment, the second symbol creation unit 310 produces second symbols through chirp signals.

The frequency response estimation unit 330 estimates a channel frequency response by applying a linear equalizer to the first symbols averaged in the symbol averaging unit 320. For this, the frequency response estimation unit 330 in this embodiment receives the second symbols from the second symbol creation unit 310. Then using the first symbols received from the symbol averaging unit 320 and the second symbols received from the second symbol creation unit 310, the frequency response estimation unit 330 estimates the channel frequency response of the transmission packet. This estimation of the channel frequency response may use a linear MMSE (Minimum Mean Squared Error) equalizer, which is referred to as an MMSE-LE (MMSE linear equalizer).

The delay time estimation unit 340 estimates a delay time by applying a matrix pencil algorithm to the channel frequency response estimated in the frequency response estimation unit 330. The matrix pencil is an algorithm used for estimating a direction of arrival (DOA) of signals. Well-known DOA (Direction of Arrival) estimation algorithms are MUSIC (Multiple Signal Classification), ESPRIT (Estimation of Signal Parameters via Rotational Invariance Techniques), and so forth. The present invention, however, in one aspect, which is described herein, uses the matrix pencil algorithm. An eigenvalue is calculated through the matrix pencil algorithm, and the delay time estimation unit 340 estimates an exact delay time (i.e., a peak point of the earliest arrived signal) of the transmission packet on the basis of the eigenvalue.

The distance calculation unit 350 calculates the distance between the transmitter node 200 and the receiver node 300, depending on the delay time estimated in the delay time estimation unit 340.

An indoor location determination method according to an exemplary embodiment of the present invention is now described.

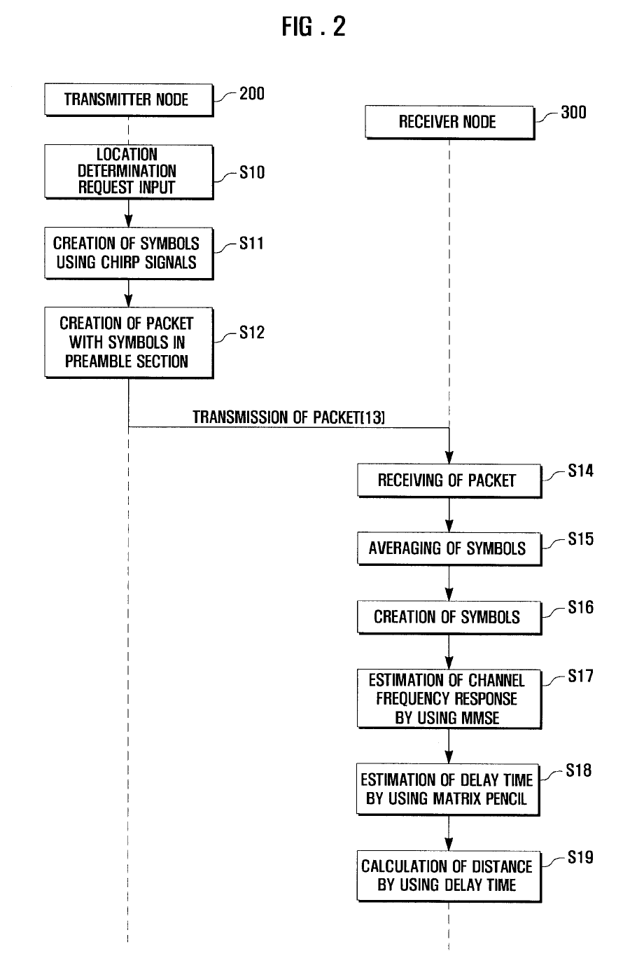

FIG. 2 is a flow diagram showing an indoor location determination method in accordance with an exemplary embodiment of the present invention.

Referring to FIGS. 1 and 2, in a step S10, the transmitter node 200 receives an input of a location determination request. This request for location determination may occur periodically in the transmitter node, or may occur by means of outer signal inputs, e.g., a poll request.

After the location determination request is inputted, the transmitter node 200 performs steps for creating the transmission packet to be delivered to the receiver node 300. That is, in a step S11, the first symbol creation unit 210 creates each first symbol. Here, the first symbol creation unit 210 uses chirp signals when creating the first symbols. Such chirp signals are well known in radar technology and therefore detailed descriptions are omitted herein.

The first symbols created in the first symbol creation unit 210 are delivered to the packet creation unit 220. Then, in a step S12, the packet creation unit 220 creates the transmission packet using the first symbols. When creating the packet, the packet creation unit 220 places a plurality of the same first symbols, e.g., eight symbols, into a preamble section of the transmission packet. As discussed previously, the first symbols may also be included within the body of the message.

After the transmission packet is created, the first RF unit 260 of the transmitter node 200 transmits the created packet which includes the first symbols, through a wireless channel in a step S13.

Instep S14, the second RF unit 360 of the receiver node 300 receives the transmission packet and delivers the received transmission packet to the symbol averaging unit 320.

In a step S15, the symbol averaging unit 320 calculates the average of the first symbols in the packet. Specifically, if eight symbols are included in the preamble section of the packet, the symbol averaging unit 320 performs a process of calculating the average of eight symbols. That is, the symbol averaging unit 320 performs averaging by calculating the sum of the amplitude of chirp signals of eight symbols and then dividing the sum by eight. Additionally, the symbol averaging unit 320 further calculates the average of noises included in such symbols, and thereby SNR can be improved. Through this averaging process, time diversity gains are acquired and therefore noises, included in the symbols due to a wireless transmission, are reduced.

After step S15, the second symbol creation unit 310 of the receiver node 300 produces a set of second symbols in a step S16 and delivers them to the frequency response estimation unit 330. These second symbols are intended to be the same as the first symbols produced by the first symbol creation unit 210 of the transmitter node 200.

When the second symbols are offered, the frequency response estimation unit 330 estimates a channel frequency response by using the second symbols and the averaged first symbols. As described above, this embodiment employs the MMSE-LE (minimum mean squared error linear equalizer), in one aspect of the invention, to estimate the channel frequency response. The following is a detailed description about the estimation of the channel frequency response.

Equation 2 represents the transmission packet the receiver node 300 receives.

r=SH+w (2)
wherein r refers to the received transmission packet, i.e., a vector of a signal to which noises are added through a wireless transmission, and
   S refers to the initial transmission packet the transmitter node 200 sends; and
   H refers to a parameter representing the channel frequency response and is represented by an L-by-1 matrix’ and
   w represents a noise vector (^{N˜(0, ρ}^{_{w}}^{²⁾}).
Additionally, S can be represented as an M-by-L matrix as:

$$S = [ \begin{matrix}s ( 0 ) & s ( 1 ) & … & S ( L - 1 ) \\ s ( 1 ) & s ( 2 ) & … & s ( L ) \\ ⋮ & ⋮ & ⋮ & ⋮ \\ s ( M - 1 ) & s ( M ) & … & s ( M + L - 1 )\end{matrix} ] \qquad ( 3 )$$

wherein L represents the number of samples determined in the frequency domain.

In one aspect of the invention, L is an arbitrary number smaller than N that is the number of samples in the time domain. Also, N refers to the total length of symbols. After the determination of L, snapshots of data are created according to the number of L by a sliding method. M refers to the number of these snapshots, and therefore M is determined as N−L+1.

To estimate a channel frequency response H from the aforementioned Equation 1, the frequency response estimation unit 330 uses in one aspect of the invention, the MMSE-LE (Minimum Mean Squared Error Linear Equalizer.) algorithm That is, the frequency response estimation unit 330 multiplies each side of Equation 1 by the pseudo-inverse (S⁺) of the initial transmission packet S. Here, S⁺ may be created by using the second symbols offered from the second symbol creation unit 310 in the step S16. According to MMSE conditions, S⁺ may be represented by the following Equation 4.

S⁺=S^{H}{S·S^{H}+(N₀/2)·I}⁻¹. (4)

The following Equation 5 is computed by multiplying each side of Equation 2 by S⁺ given in Equation 4.

\tilde{r}=S⁺r=S⁺SH+S⁺w=H+\tilde{w}. (5)

Through Equation 5, the frequency response estimation unit 330 acquires a channel frequency response H.

Then, in a step S18, the delay time estimation unit 340 estimates a delay time by using the above channel frequency response H and a matrix pencil algorithm.

In general, the channel frequency response estimated regarding the k-th frequency sample is represented as.

$$\tilde{H} ( j2π k Δ f ) = {\sum }_{l = 1}^{{L}_{p}} {α}_{l} {z}_{l}^{k} + {n}_{l} \\ where {z}_{l} = {e}^{- j2π Δ f \cdot {τ}_{l}} with Δ f = 1 / N \cdot Δ t \qquad ( 6 )$$

Here, L_{P} represents the number of multiple paths in a wireless channel, and αₗ represents the strength of a signal received through each path. In addition, Tₗ refers to the delay time of each path, and Δf refers to the frequency sampling interval.

To apply a matrix pencil algorithm, a signal of the k-th frequency sample as shown in Equation 6 may be represented as an (N−P)×(P+1) matrix as:

$$X = [ \begin{matrix}H ( 0 ) & … & H ( P ) \\ ⋮ & ⋰ & ⋮ \\ H ( N - P - 1 ) & … & H ( N - 1 )\end{matrix} ] \qquad ( 7 )$$

Here, P refers to a pencil parameter.

Then, (N−P)×P matrices X₀ and X₁ are defined from the above. These matrices X₀ and X₁ are composed of initial and final P vectors of X. Matrices X₀ and X₁ may be represented

$${X}_{0} = [ \begin{matrix}H ( 0 ) & … & H ( P - 1 ) \\ ⋮ & ⋰ & ⋮ \\ H ( N - P - 1 ) & … & H ( N - 2 )\end{matrix} ] , \\ {X}_{1} = [ \begin{matrix}H ( 0 ) & … & H ( P ) \\ ⋮ & ⋰ & ⋮ \\ H ( N - P ) & … & H ( N - 1 )\end{matrix} ] \qquad ( 8 )$$

as:

Alternatively, matrices X₀ and X₁ may be represented as:

X₀=Z₁AZ₂, X₁=Z₁AZ₀Z₂ (9)

wherein, Z₁ and Z₂ are represented as:

$${Z}_{1} = [ \begin{matrix}1 & … & 1 \\ ⋮ & ⋰ & ⋮ \\ {z}_{1}^{( N - P - 1 )} & … & {z}_{{L}_{P}}^{( N - P - 1 )}\end{matrix} ] , {Z}_{2} = [ \begin{matrix}1 & {z}_{1} & … & {z}_{1}^{P - 1} \\ ⋮ & ⋮ & ⋰ & ⋮ \\ 1 & {z}_{{L}_{P}} & … & {z}_{{L}_{P}}^{P - 1}\end{matrix} ] \qquad ( 10 )$$

Additionally, Z₀ and A are diagonal matrices which have diagonal elements Z₁ . . . Z_{M} and a₁ . . . a_{M}, respectively.

Through a generalized eigenvalue decomposition shown in Equation 11, a generalized eigenvalue λ(=Z_{Lp}) of a matrix pair [X1, X0] can be computed as:

X₁−λ₀=Z₁A[Z₀−λI]Z₂ (11)

wherein the maximum eigenvalue is given by λₘₐₓ=Z_{Lp}.

The time delay may be deduced from the Equation 6 as:

$${τ}_{{L}_{p}} = - \frac{Im ( ln ( {z}_{{L}_{p}} ) )}{2 πΔ f} \qquad ( 12 )$$

Utilizing Equation 12, the delay time estimation unit 340 calculates the delay time T_{Lp} at the maximum eigenvalue Z_{Lp}. Here, T_{Lp} refers to the delay time of the earliest arrived transmission packet at the receiver node 300.

After the estimation of the delay time, the distance calculation unit 350 calculates the distance between the transmitter node 200 and the receiver node 300 in a step S19, depending on the delay time T_{Lp} estimated in the previous step S18. and the transmission velocity of the packet.

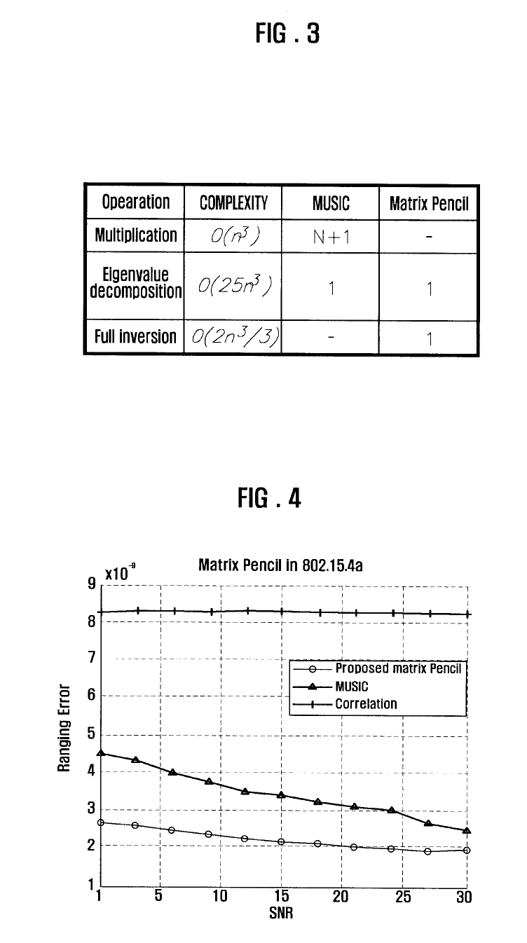

The above-discussed method for indoor location determination using a matrix pencil in the present embodiment is distinguished from TOA estimation using another traditional algorithm (e.g., MUSIC algorithm). FIG. 3 is a view showing the complexity of a matrix pencil and MUSIC. As shown in FIG. 3, a matrix pencil has an advantage in complexity over MUSIC algorithm.

Additionally, the indoor location determination method using a matrix pencil according to the present invention has a lower rate of errors than the TOA estimation performance. FIG. 4 is a graph showing a ranging error with regard to CSS PHY of IEEE802.15.4a. The horizontal axis represents SNR (dB). Referring to FIG. 4, it will be appreciated that a matrix pencil has a better performance (i.e., a smaller ranging error) than the other TOA estimation techniques. Therefore, the delay time estimation using a matrix pencil in the present invention can allow the estimation of a more exact delay time in comparison with conventional methods.

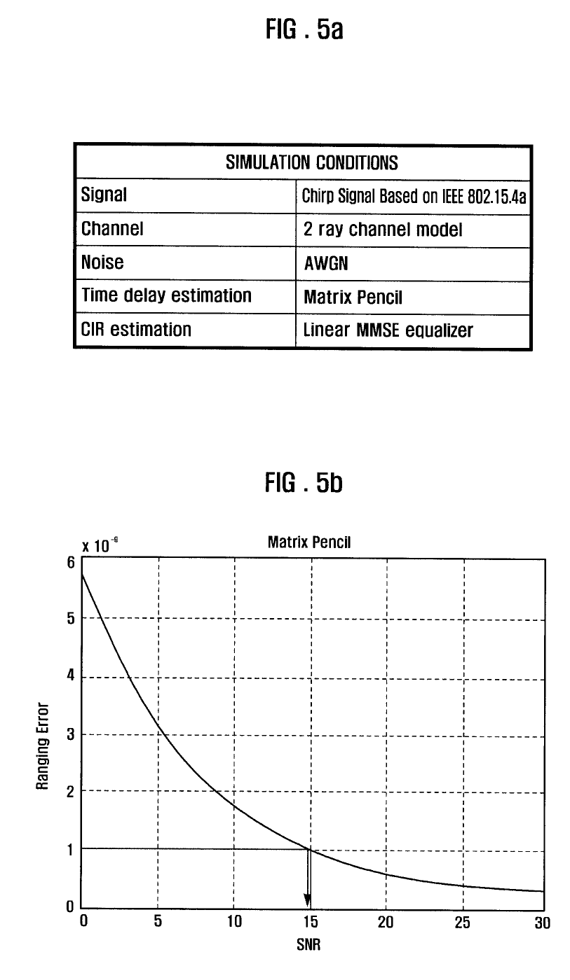

FIG. 5A is a view showing simulation conditions of an indoor location determination method in accordance with an exemplary embodiment of the present invention. Additionally, FIG. 5B is a graph showing a ranging error in 2-ray channel model according to conditions given in FIG. 5A. FIGS. 5A and 5B show a case where multiple paths are two (2-ray). Referring to FIGS. 5A and 5B, the present invention has a ranging error of associated with a one nanosecond (1 ns) with amounts to a distance in the order oft 30 cm when SNR (signal-to-noise ratio) is 15 dB or more. Therefore, the present invention with very lower ranging errors can be used as core technology of location-based applications or services.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. While this invention has been particularly shown and described with reference to an exemplary embodiment thereof, it will be understood by those skilled in the art that various changes in form and details may be made therein without departing from the spirit and scope of the invention as defined by the appended claims.

For example, although the above-discussed embodiment is a technique for determining indoor locations, the present invention is also applied to outdoor location determination.

Furthermore, although the aforesaid embodiment uses chirp signals to form symbols, the present invention is not limited to this only chirp signals and may also use any other kinds of signals being capable of forming symbols.

Additionally, although the above-described embodiment uses a case where eight symbols are included in a packet, the present invention is not limited to this only and may also use different numbers of symbols.

What is claimed is:

1. A location determination method, operable in a computer system comprising:
receiving a transmission packet at a receiver node, said transmission packet having a plurality of same symbols;
calculating a delay time by using the symbols in the transmission packet and a matrix pencil algorithm; and
calculating a distance between the transmitter node and the receiver node by using the delay time.

2. The method of claim 1, wherein the calculating of the delay time includes:
estimating a channel frequency response from the symbols; and
calculating the delay time by using the channel frequency response and the matrix pencil algorithm.

3. The method of claim 2, wherein the estimating of the channel frequency response includes:
acquiring a time diversity gain by averaging the symbols.

4. The method of claim 3, wherein the estimating of the channel frequency response is performed by applying a linear equalizer to the averaged symbols.

5. The method of claim 4, wherein the linear equalizer is a minimum mean squared error linear equalizer (MMSE-LE).

6. The method of claim 4, wherein the symbols are included within a preamble section of the transmission packet.

7. The method of claim 6, wherein the symbols are formed of chirp signals.

8. The method of claim 7, wherein the transmission packet has eight symbols.

9. A location determination system comprising:
a transmitter node creating and transmitting a transmission packet having a plurality of same symbols; and
a receiver node receiving the transmission packet and calculating a delay time by using the symbols in the transmission packet and a matrix pencil algorithm.

10. The system of claim 9, wherein the receiver node includes:
a frequency response estimation unit estimating a channel frequency response from the symbols; and
a delay time estimation unit estimating the delay time by using the channel frequency response and the matrix pencil algorithm.

11. The system of claim 10, wherein the receiver node further includes:
a symbol averaging unit acquiring a time diversity gain by averaging the symbols.

12. The system of claim 11, wherein the frequency response estimation unit estimates the channel frequency response by applying a linear equalizer to the averaged symbols.

13. The system of claim 12, wherein the linear equalizer is a minimum mean squared error linear equalizer (MMSE-LE).

14. The system of claim 10, wherein the receiver node further includes:
a distance calculation unit calculating a distance between the transmitter node and the receiver node by using the delay time.

15. The system of claim 10, wherein the transmitter node includes:
a first symbol creation unit creating the symbols; and
a packet creation unit creating the transmission packet having the symbols.

16. The system of claim 15, wherein the receiver node further includes:
a second symbol creation unit creating the same symbols as those transmitted in the transmission packet, and sending the second symbols to the frequency response estimation unit.

17. The system of claim 10, wherein the first symbols are included within a preamble section of the transmission packet.

18. The system of claim 17, wherein the first symbols are formed of chirp signals.

19. The system of claim 18, wherein the transmission packet has eight symbols.

20. A location determination device comprising:
a processor in communication with a memory, the memory including code which when accessed by the processor causes the processor to:
receive a packet of same symbols received by a receiving unit;
estimate a channel frequency response from the received symbols, wherein said channel frequency response utilizes a time diversity gain obtained by averaging the received symbols.
calculating a delay time by using the channel frequency response and a matrix pencil algorithm; and
calculating a distance by using the estimated delay time and speed of propagating said symbols

21. The device of claim 20 wherein said processor estimates the channel frequency response by applying a linear equalizer to the averaged symbols.

22. The device of claim 21, wherein the linear equalizer is a minimum mean squared error linear equalizer (MMSE-LE).

23. The device of claim 20, wherein the symbols are included within a preamble section of a transmission packet.

24. The device of claim 20, wherein the symbols are formed of chirp signals.

25. The device of claim 7, wherein a predetermined number of symbols are including in said transmission packet.
